(19) United States
(12) Patent Application Publication
(10) Pub. No.: US 2010/0121768 A1
(43) Pub. Date: May 13, 2010

(54) METHOD AND APPARATUS FOR BULK PAYMENT ACCOUNT

(75) Inventors: Anant Nambiar, Larchmont, NY (US); Geetha Panchapakesan, Scarsdale, NY (US)

Correspondence Address: Ryan, Mason & Lewis, LLP;Suite 205, 1300 Post Road, Fairfield, CT, 06824, US

(73) Assignee: MasterCard International Incorporated, Purchase, NY (US)

(21) Appl. No.: 12/270,180

(22) Filed: Nov. 13, 2008

(51) Int. Cl. G06Q 30/00; G06Q 50/00; G06Q 20/00

(52) U.S. Cl. 705/80

(57) ABSTRACT

An offeror offers a first plurality of payment device holders a first offer including a negotiated deal on a first ware, which is available for a first predetermined period of time. Those certain holders among the first plurality of payment device holders who wish to accept the first offer (“first offer accepting holders”) are registered. Registration includes obtaining at least personal identifying information and corresponding registered payment device account numbers for the first offer accepting holders. A first plurality of transactions are processed in accordance with the negotiated deal on the first ware. The first plurality of transactions are purchases of the first ware, by the first offer accepting holders, during the first predetermined period of time. In some circumstances, the offeror does not require purchase of any product or service other than the first ware for which the negotiated unit price is offered in order for the first offer accepting holders to obtain the negotiated unit price on the first ware. In some cases, monetary amounts of the first plurality of transactions are adjusted to reflect the negotiated deal, contemporaneously with the first plurality of transactions.

### FIELD OF THE INVENTION

The invention relates generally to electronic commerce, and, more particularly, to electronic payment systems.

### BACKGROUND OF THE INVENTION

Various schemes have been proposed for marketing and pricing in connection with payment devices, such as credit and debit cards. U.S. Pat. No. 6,980,960 of Hajdukiewicz et al. discloses a system and method for providing a fuel purchase incentive. The incentive is provided incident to the sale of a vehicle. With respect to the sale of an automobile, the incentive consists of a program price, for example a discount price or a capped maximum price, for a specified quantity of a specified brand and type of gasoline. The incentive is calculated as a function of the anticipated geographical and other use factors of the automobile buyer. The incentive information is provided to the buyer at the time of purchase of the automobile and stored for use by an incentive program operator. When the buyer purchases gasoline pursuant to the incentive program that is of a specified brand, grade and quantity, the purchase information is transmitted to the incentive program operator. A rebate, equal generally to the difference between the retail price and the program price, is calculated and transmitted to a credit card processor for application to a credit card bill. A credit card account identifier is the preferred method of identifying the buyer and providing rebates under the program. The invention has application to vehicles other than automobiles and fuels other than gasoline. In one embodiment, a hedge program may be developed to offset the risk associated with guaranteeing the price of the fuel.

In some cases, card holders, including but not limited to holders of gasoline credit cards, are offered a percentage back on purchases, as a cash back or statement rebate.

### SUMMARY OF THE INVENTION

Principles of the invention provide techniques for a bulk payment account. An exemplary embodiment of a method (which can be computer-implemented), according to one aspect of the invention, includes the step of offering a first plurality of payment device holders a first offer including a negotiated deal (such as a unit price or a discount) on a first ware. The negotiated deal on the first ware is available for a first predetermined period of time. Also included is registering those certain holders among the first plurality of payment device holders who wish to accept the first offer (“first offer accepting holders”). The registering of the first offer accepting holders includes obtaining at least personal identifying information and corresponding registered payment device account numbers for the first offer accepting holders. An additional step includes processing a first plurality of transactions in accordance with the negotiated deal on the first ware. The first plurality of transactions are purchases of the first ware, by the first offer accepting holders, during the first predetermined period of time. The step of offering the first offer is carried out by an offeror and in at least some cases, the offeror does not require purchase of any product or service, other than the first ware for which the negotiated deal is offered, in order for the first offer accepting holders to obtain the negotiated deal on the first ware. In some embodiments, the processing step includes adjusting monetary amounts of the first plurality of transactions to reflect the negotiated deal, contemporaneously with the first plurality of transactions.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of a system (or apparatus) including a memory and at least one processor that is coupled to the memory and operative to perform or otherwise facilitate exemplary method steps. In some cases, the at least one processor includes at least a front end communications processor, which is associated with a file structure listing the registered payment device account numbers for the first offer accepting holders. Yet further, in another aspect, one or more embodiments of the invention or elements thereof can be implemented in the form of means for carrying out or otherwise facilitating one or more of the method steps described herein; the means can include hardware module(s), software module(s), or a combination of hardware and software modules.

These and other features and advantages of the invention will become apparent from the following detailed description of illustrative embodiments thereof, which is to be read in connection with the accompanying drawings.

### BRIEF DESCRIPTION OF THE DRAWINGS

FIG. 1 shows an example of a system that can implement techniques of the invention;

FIG. 2 depicts an exemplary inter-relationship between and among: (i) a payment network configured to facilitate transactions between multiple issuers and multiple acquirers, (ii) a plurality of customers, (iii) a plurality of merchants, (iv) a plurality of acquirers, and (v) a plurality of issuers;

FIG. 3 shows a flow chart of exemplary method steps, according to an aspect of the invention;

FIG. 4 is a block diagram of an exemplary computer system useful in one or more embodiments of the invention; and

FIG. 5 shows an exemplary architecture including a front end communications processor with an associated file structure.

### DETAILED DESCRIPTION OF PREFERRED EMBODIMENTS

One or more embodiments of the invention are based on negotiated rates with the merchant, unlike current techniques. In particular, in one or more embodiments, holders of a particular type of payment card, such as a MasterCard® card, receive a negotiated rate for key products and/or services when using the particular type of payment card. In one or more instances of the invention, the rate remains flat for a period of time regardless of the actual price of the product and/or service. Non-limiting examples of products and services on which such a “bulk” rate could be offered include fuel, child-care services, air travel, and the like. Advantageously, card holders benefit from the lower price while the operator of a payment network (discussed further below; by way of example and not limitation, MasterCard International Incorporated of Purchase, New York, USA) benefits by inducing a greater volume of transactions to be carried out with the network.

Thus, in one or more embodiments, exclusive negotiated rates will be offered on payment cards for specific products and services. The choice of products and services can be based, for example, on consumer interest and/or merchant participation. Cardholders can be required to register for the program and in one or more embodiments, are able to obtain the negotiated rate only if they use the registered card or cards. In one or more instances, the negotiated rate is offered for a specific period of time; for example, until one year from the date of registration. At the end of that time, the rate will potentially change and the cardholder will have to re-register to continue to obtain the bulk rate.

It should be noted that payment devices other than cards may be employed, and that in some cases, aspects of the invention could be implemented using a payment card account without a physical card or device associated therewith; for example, a purchasing card.

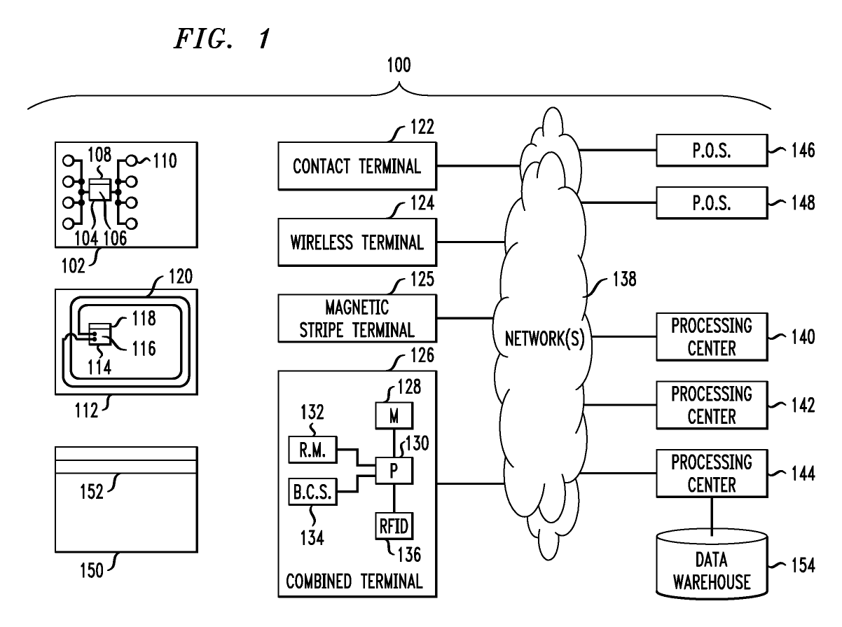

Attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the invention. Other types of devices could include a conventional card 150 having a magnetic stripe 152, an appropriately configured cellular telephone handset, and the like. Indeed, techniques of the invention can be adapted to a variety of different types of cards, terminals, and other devices, configured, for example, according to a payment system standard (and/or specification). As noted, in some cases, techniques of the invention can be applied to card accounts having a card number but no physical card or other device associated therewith, such as the aforementioned purchasing cards.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used to implement aspects of the invention is the MULTOS® operating system licensed by StepNexus Inc. Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible standard to which such applications may conform is the EMV payment standard set forth by EMVCo, LLC (http://www.emvco.com). It will be appreciated that, strictly speaking, the EMV standard defines the behavior of a terminal; however, the card can be configured to conform to such EMV-compliant terminal behavior and in this sense is itself EMV-compliant. It will also be appreciated that applications in accordance with the invention can be configured in a variety of different ways.

In some cases, implementations conform to pertinent ISO standards, such as ISO 8583. Individual entities or groups may develop specifications within this standard. Some messages (for example, authorization request and response) are defined within ISO 8583, while new messages may be implemented by the skilled artisan, given the teachings herein, for example, as part of a specification conforming to the ISO 8583 standard. For example, in some embodiments, a processing by exception approach may be adopted; based on the card holder's account number, a determination is made whether the card holder is eligible for the negotiated deal.

As noted, cards 102, 112 are examples of a variety of payment devices that can be employed with techniques of the invention. The primary function of the payment devices may not be payment, for example, they may be cellular phone handsets that implement techniques of the invention. Such devices could include cards having a conventional form factor, smaller or larger cards, cards of different shape, key fobs, personal digital assistants (PDAs), appropriately configured cell phone handsets, or indeed any device with the capabilities to implement techniques of the invention. The cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to facilitate execution of one or more method steps. The applications can be, for example, application identifiers (AIDs) linked to software code in the form of firmware plus data in a card memory such as an electrically erasable programmable read-only memory (EEPROM). Again, note that “smart” cards are not necessarily required and a magnetic stripe card can be employed.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® network of MasterCard International Incorporated, Purchase, New York, USA). More than one network could be employed to connect different elements of the system. Processing centers 140, 142, 144 can include, for example, a host computer of an issuer of a payment device (or processing functionality of other entities discussed herein).

Many different retail or other establishments, represented by points-of-sale 146, 148, can be connected to network 138. Each such establishment can have one or more terminals. Further, different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

The portable device can include a body portion. For example, this could be a laminated plastic body (as discussed above) in the case of “smart” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. In some instances, the aforementioned bar code scanner 134 and/or RFID tag reader 136 can be provided, and can be coupled to the processor, to gather data, such as a product identification, from a UPC code or RFID tag on a product to be purchased.

The above-described devices 102, 112 can be ISO 7816-compliant contact cards or devices or ISO 14443-compliant proximity cards or devices. In operation, card 112 can be touched or tapped on the terminal 124 or 126, which then contactlessly transmits the electronic data to the proximity IC chip in the card 112 or other wireless device. Magnetic stripe cards can be swiped in a well-known manner. The card number may be supplied in other ways besides actual presentment of the card (indeed, this would be required for accounts where no physical card exists).

One or more of the processing centers 140, 142, 144 can include a database such as a data warehouse 154 for storing information of interest.

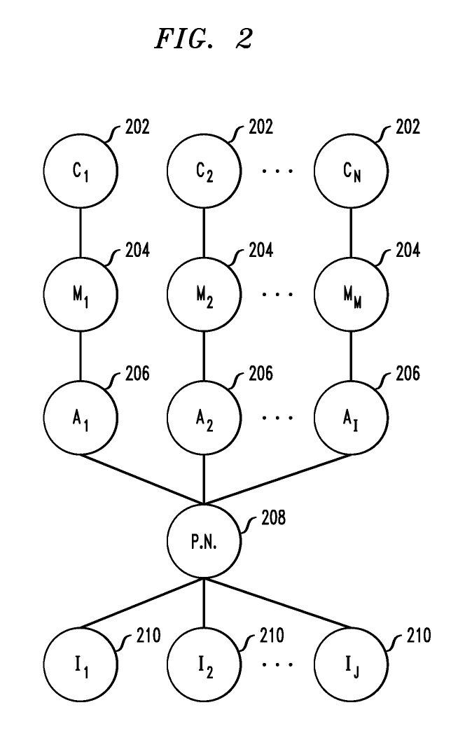

With reference to FIG. 2, an exemplary relationship among multiple entities is depicted. A number of different customers 202, C₁, C₂ . . . C_{N}, interact with a number of different merchants 204, M₁, M₂ . . . M_{M}. Merchants 204 interact with a number of different acquirers 206, A₁, A₂ . . . A₁. Acquirers 206 interact with a number of different issuers 210, I₁, I₂ . . . I_{J}, through a single operator 208 of a payment network configured to facilitate transactions between multiple issuers and multiple acquirers; for example, MasterCard International Incorporated, operator of the above-mentioned BANKNET® network, or Visa International Service Association, operator of the VISANET® network. In general, N, M, I, and J are integers that can be equal or not equal.

In the context of one or more embodiments of the invention, card holder 202 could hold a device such as 102, 122, 150 (or a cardless account with an account number); merchant 204 could have a terminal such as 122, 124, 125, 126, and the entities 206, 208, 210 could operate processing centers such as 140, 142, 144 (with data storage 154 as needed). Network(s) 138 could, as noted, include a virtual private network (VPN) and/or the Internet; the VPN could be, for example, the aforementioned BANKNET® network, and entity 208 could be, for example, an entity such as MasterCard International Incorporated.

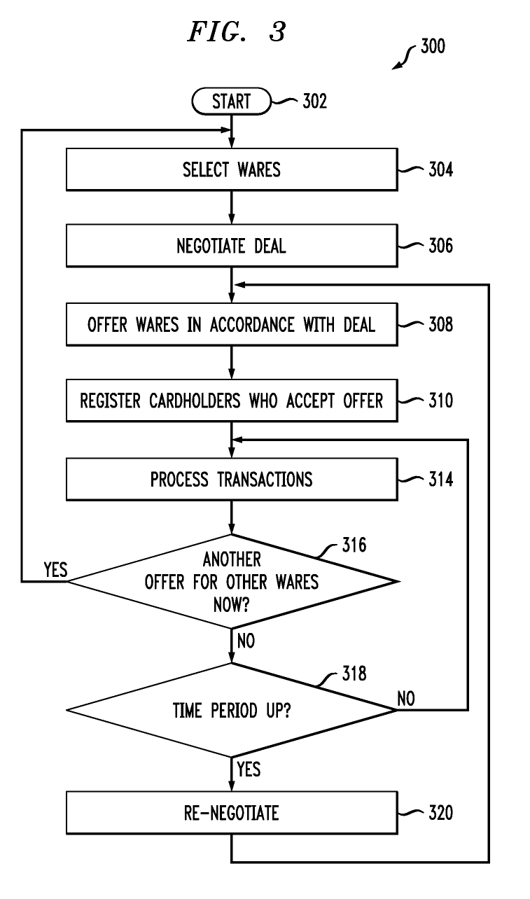

Attention should now be given to flow chart 300 of FIG. 3, which depicts an exemplary method according to an aspect of the invention. After beginning at step 302, optional step 304 includes selecting first wares based on at least consumer interest and merchant participation. “Wares” in this context can include goods or services. Fuel, such as automotive fuel (gasoline, diesel, etc.) is a non-limiting example of a ware that is a good. Child care and air travel are non-limiting examples of wares that are services. Optional step 306 includes negotiating a negotiated deal (e.g., fixed unit price, percentage discount, or fixed discount) for the first ware with a first merchant 204. Steps 304 and 306 may be carried out, for example, by the operator of the payment network. One or more merchants may be approached on a merchant-by-merchant basis; for example, a unit price may be negotiated with Acme gasoline and another unit price (the same or different) may be negotiated with Zenith gasoline. A non-limiting example of a fixed unit price is $2.99 per gallon for Acme regular unleaded gasoline; a non-limiting example of a fixed discount is $0.25 off every gallon of Acme regular unleaded gasoline; and a non-limiting example of a percentage discount is 10% off every gallon of Acme regular unleaded gasoline.

Step 308 includes offering a first plurality of payment device holders 202 a first offer including the negotiated deal on the first ware. Step 308 may be carried out, for example, by a joint advertising campaign from the payment network operator and the merchant. In some embodiments, the negotiated unit price (or other negotiated deal) on the first ware is fixed, for a first predetermined period of time, and/or is independent of the market price for the first ware. Step 310 includes registering those certain holders (“first accepting holders”) among the first plurality of payment device holders who wish to accept the first offer. Such registration can include, for example, obtaining at least personal identifying information and corresponding registered payment device account numbers for the first offer accepting holders. Step 310 could be carried out, for example, by having the first accepting holders visit a web site in response to advertising, or mailing in a card or other paper form which might have been displayed adjacent the wares of interest (e.g., near a gasoline pump) or have been mailed to card holders as part of a monthly statement or otherwise. Step 310 may involve, for example, collaboration between the merchant and payment network operator.

Step 314 includes processing a first plurality of transactions in accordance with the negotiated deal on the first ware. The first plurality of transactions are purchases of the first ware, by the first offer accepting holders, during the first predetermined period of time. The step 308 of offering the first offer is carried out by an offeror (by way of example and not limitation, the offeror in this context could be the payment network operator working together with the merchant) and, in some embodiments, the offeror does not require purchase of any product or service other than the first ware for which the negotiated deal is offered in order for the first offer accepting holders to obtain the negotiated deal on the first ware.

In some cases, step 314 is carried out “after the fact” via a statement rebate which adjusts for the difference between the negotiated unit price (or other negotiated deal) and the market price. Such rebate may be limited to the wares for which the deal has been negotiated, and as just noted, in some embodiments, does not require the purchase of any other wares in order for the card holder to obtain the negotiated deal.

In other instances, the registered card holder is charged in accordance with the negotiated deal at the time of the transaction, based on recognizing the card number as a registered card. Stated in another way, the step 314 of processing the first plurality of transactions includes adjusting monetary amounts of the first plurality of transactions to reflect the negotiated unit price (or other negotiated deal), contemporaneously with the first plurality of transactions. This can be effectuated anywhere in the processing chain discussed with regard to FIG. 2; for example, by employing a flag during the authorization request and response. This approach can be carried out, for example, by upgrading software in terminals 122, 124, 125, 126 (e.g., gasoline pumps with card readers); in a presently preferred approach, use is made of a front end communications processor such as a MASTERCARD INTERFACE PROCESSOR™ or MIP™ processor (trademarks of MasterCard International, Inc. of Purchase, New York), as will be discussed further below.

As indicated in decision block 316, in one or more instances, the offeror may decide to offer a second ware at a particular time, contemporaneous with, or after, the offering of the first ware. In such case, any or all of steps 304 through 314 can be repeated. Thus, in this repetition, optional repeated step 304 includes selecting the second ware using, for example, criteria similar to those used to select the first ware. Optional repeated step 306 includes negotiating a negotiated unit price (or other negotiated deal) for a second ware with a second merchant 204. Repeated step 308 includes offering a second plurality of payment device holders 202 a second offer including the negotiated unit price (or other negotiated deal) on the second ware. The negotiated unit price (or other negotiated deal) on the second ware can be fixed, for a second predetermined period of time, and/or can be independent of a market price for the second ware. Repeated step 310 includes registering those certain holders (“second offer accepting holders”) among the second plurality of payment device holders who wish to accept the second offer.

Repeated step 314 includes processing a second plurality of transactions in accordance with the negotiated unit price (or other negotiated deal) on the second ware. The second plurality of transactions are purchases of the second ware, by the second offer accepting holders, during the second predetermined period of time. The repeated step 308 of offering the second offer is carried out by the offeror and, in some instances, the offeror does not require purchase of any product or service, other than the second ware for which the negotiated unit price is offered, in order for the second offer accepting holders to obtain the negotiated unit price on the second ware. Any or all of steps 304-314 can be repeated as needed whenever a new offer is to be made; for example, a first ware could be gasoline offered to a first group of cardholders; a second ware could be child care offered to a second group of cardholders; a third ware could be air travel offered to a third group of cardholders, and so on.

It should be noted that in some instances, offers are targeted offers (based on demographics, previous behavior, or the like), such that the people offered gasoline deals may be different than people offered day care deals, while in other instances, across-the-board offers might be made to all cardholders, or by general advertising, and so on.

Where another offer is not to be made, processing flows to decision block 318, to determine whether the predetermined time period is up (e.g., expired or about to expire soon) for the particular ware; if not, processing continues back in block 314; while if the time period is up, the unit price (or other deal) can be re-negotiated in step 320, and then the particular ware for which the predetermined time has expired can be offered to the appropriate card holders under conditions of the new negotiated deal (e.g., at the new unit price). That is, steps may include re-negotiating the negotiated unit price (or other negotiated deal) for the first ware with the first merchant to obtain a re-negotiated unit price (or other re-negotiated deal) for the first ware for a second predetermined time period, as per step 320; offering the first offer accepting holders an opportunity to renew the first offer at the re-negotiated unit price (or other re-negotiated deal) (when step 308 is repeated for the re-negotiated price(or other re-negotiated deal)); renewing the registrations of those certain holders among the first offer accepting holders who wish to renew (“renewing holders”)(when step 310 is repeated for the re-negotiated price(or other re-negotiated deal)); and processing a second plurality of transactions in accordance with the re-negotiated unit price (or other re-negotiated deal) on the first ware (when step 314 is repeated for the re-negotiated price(or other re-negotiated deal)). In this context, the second plurality of transactions include purchases of the first ware, by the renewing holders, during the second predetermined time period. Similar steps are carried out when the predetermined time periods expire for the other wares. The pre-determined time periods may be the same or different for each ware.

In at least some instances, the negotiated unit price for a given ware is exclusive to the brand of payment device of the corresponding plurality of payment device holders 202 (broadly understood to include the brand of card per se, such as MasterCard card or Visa card; a co-brand with the issuer, such as Bank of Anytown MasterCard card; and/or a co-brand with the merchant, such as an Acme Gasoline MasterCard card). In one or more embodiments, separate fuel cards (or other separate cards) are not needed. That is, the first (or second, third, etc.) offer accepting holders hold payment devices prior to the offering step and the first (or second, third, etc.) plurality of transactions are carried out with the same payment devices, without requiring any supplemental payment devices.

In one or more embodiments, a third party is not required for processing. That is, the first (or second, third, etc.) plurality of transactions are carried out by communication between the first (or second, third, etc.) merchant 204 and issuers 210 of given ones of the devices (or cardless accounts), via at least one acquirer 206 and a payment network 208 operating according to a payment system specification and/or standard, substantially without third party involvement. “Substantially” without third party involvement means without any third party involvement, or with third parties only carrying out traditional roles such as an issuer processor, as opposed to a third party incentive program operator.

Various combinations and subsets of the steps in FIG. 3 are possible. For example, an exemplary method could include offering a first plurality of payment device holders a first offer comprising a negotiated deal on a first ware, with said negotiated deal on said first ware being available for a first predetermined period of time, as per step 308; registering those certain holders among said first plurality of payment device holders who wish to accept said first offer, said certain holders among said first plurality of payment device holders comprising first offer accepting holders, said registering of said first offer accepting holders comprising obtaining at least personal identifying information and corresponding registered payment device account numbers for said first offer accepting holders, as per step 310; and, as per step 314, processing a first plurality of transactions in accordance with said negotiated deal on said first ware, wherein said first plurality of transactions include purchases of said first ware, by said first offer accepting holders, during said first predetermined period of time, and wherein said processing includes adjusting monetary amounts of said first plurality of transactions to reflect said negotiated deal, contemporaneously with said first plurality of transactions. A third party might or might not be involved, and purchase of other wares might or might not be required. Said negotiated deal could be, for example, a negotiated unit price fixed for said first predetermined period of time and independent of a market price for said first ware (or another negotiated deal).

Reference should now be had to FIG. 5 for an exemplary architecture useful in one or more embodiments of the invention. Elements in FIG. 5 similar to those in FIG. 2 have received the same reference character incremented by three hundred. As shown at 502, the holder of a card or other payment device interacts with a terminal at a facility of a merchant 504, corresponding, e.g., to terminals and points of sale as described with respect to FIG. 1. The merchant sends transaction information to an acquirer 506, for example, via a network such as described in FIG. 1. A front end communications processor 550, such as a MASTERCARD INTERFACE PROCESSOR™ or MIP™ processor (trademarks of MasterCard International, Inc. of Purchase, New York), modified in accordance with teachings herein, can be provided between acquirer 506 and a telecommunications network such as VPN 508 (which can be, for example, a payment processing network). Processor 550 can be located in a variety of places, e.g., at the acquirer's facility, and could be operated by, e.g., an acquirer.

Another front-end communications processor 552, such as a MIP™ processor, can be located, e.g., at the facility of an issuer 510 to provide access to the aforementioned VPN 508. Of course, there may be a plurality of similarly-equipped issuer, and other, facilities.

A file structure 554 may be provided on, or associated with, processor 550. File structure 554 may include, for example, a list of account numbers of cards that have registered for the special pricing. Processor 550 may be programmed to check the account numbers in authorization messages that it receives from merchant 504 and compare them against file structure 554 to see if they have registered and are eligible for the special pricing, in which case the messages may be flagged for special processing, and/or the price may be adjusted to reflect the negotiated deal before further processing, and so on. File structure 554 may be periodically updated to reflect new registrations and the like. United States Patent Application Publication Nos. 2007-0262139 and 2008-0033880, the complete disclosures of both of which are expressly incorporated herein by reference in their entireties for all purposes, disclose techniques wherein a processor such as a MIP processor may be used in a system to maintain a list of card numbers for access control to a transit system or the like. Techniques in these applications may, given the teachings herein, be adapted to implement the aforesaid processor 550 with file structure 554 for identifying registered cards eligible for the special negotiated deal.

Thus, to summarize and provide additional detail, in one or more embodiments, the accounts and/or account ranges that are set up to get the discounted rate will be programmed in the MIP or similar processor 550 (for example, stored in file structure 554). Logic (for example, a software program) on the processor 550 will use the account number and the merchant identifier (Merchant ID) for the particular merchant 504 to determine whether the given account is eligible for a discounted rate for the particular transaction. Processor 550 will then send the authorization request to the issuer 510 for the discounted amount (i.e., in accordance with the negotiated deal). The discussion of processor 550 is, of course, of primary interest in the case where the discounted price is reflected at the point-of-sale, and is not needed in the case were an after-the-fact statement rebate is employed.

### System and Article of Manufacture Details

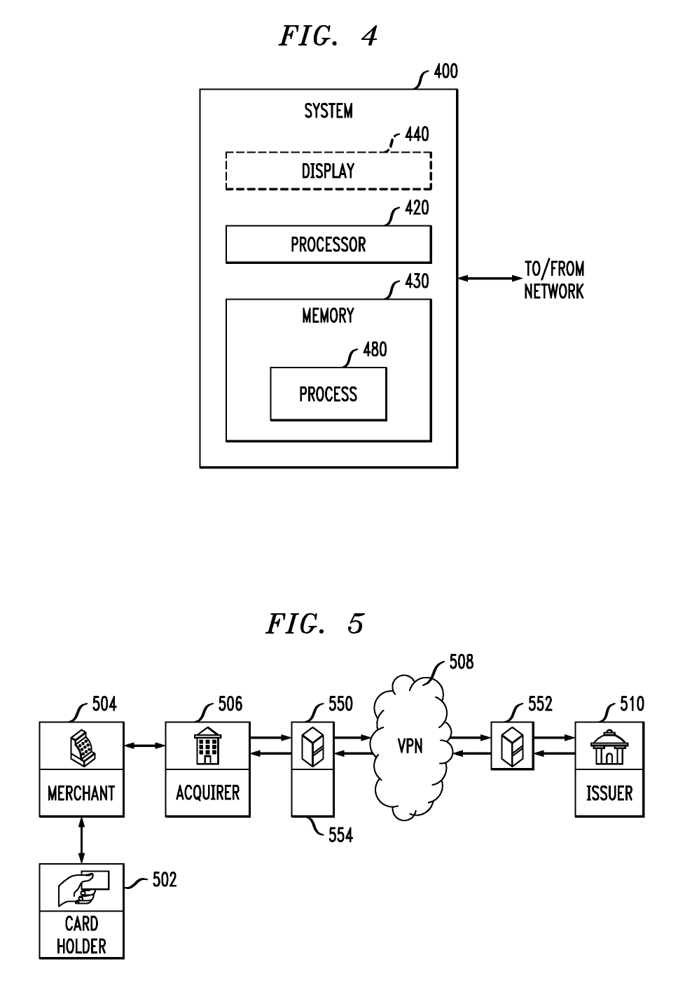

The invention can employ hardware and/or software aspects. Software includes but is not limited to firmware, resident software, microcode, etc. Software might be employed, for example, in connection with one or more of a terminal 122, 124, 125, 126; a processing center 140, 142, 144 (optionally with data warehouse 154) of a merchant, issuer, acquirer, processor, payment processing network operator, or other entity as depicted in FIGS. 2 & 5; a MIP processor or other front-end communications processor 550, 552; and the like. Firmware might be employed, for example, in connection with payment devices such as cards 102, 112. FIG. 4 is a block diagram of a system 400 that can implement part or all of one or more aspects or processes of the invention. As shown in FIG. 4, memory 430 configures the processor 420 (which could correspond, e.g., to processor portions 106, 116, 130, processors of remote hosts in centers 140, 142, 144, processors associated with any entities as depicted in FIGS. 2 & 5, MIP processors or other front-end communications processors 550, 552, and the like) to implement one or more aspects of the methods, steps, and functions disclosed herein (collectively, shown as process 480 in FIG. 4). Different method steps can be performed by different processors. The memory 430 could be distributed or local and the processor 420 could be distributed or singular. The memory 430 could be implemented as an electrical, magnetic or optical memory, or any combination of these or other types of storage devices (including memory portions as described above with respect to cards 102, 112). It should be noted that if distributed processors are employed, each distributed processor that makes up processor 420 generally contains its own addressable memory space. It should also be noted that some or all of computer system 400 can be incorporated into an application-specific or general-use integrated circuit. For example, one or more method steps could be implemented in hardware in an ASIC rather than using firmware. Display 440 is representative of a variety of possible input/output devices (e.g., displays, mice, keyboards, and the like).

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a tangible recordable (or read-only) storage medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on elements 102, 112, 122, 124, 125, 126, 140, 142, 144, 550, 552, processors associated with any entities as depicted in FIGS. 2 & 5, and the like, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, the aforementioned terminals 122, 124, 125, 126; processing centers 140, 142, 144 with data warehouse 154; processors associated with any entities as depicted in FIGS. 2 & 5; MIP processors or other front-end communications processors 550, 552; and the like, or payment devices such as cards 102, 112; can make use of computer technology with appropriate instructions to implement method steps described herein. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). Provision to enter a card number for a cardless account can also be made (e.g., typing, reading a file, and so on).

Accordingly, it will be appreciated that one or more embodiments of the invention can include a computer program comprising computer program code means adapted to perform one or all of the steps of any methods or claims set forth herein when such program is run on a computer, and that such program may be embodied on a tangible computer readable storage medium. Further, one or more embodiments of the invention can include a computer comprising code adapted to cause the computer to carry out one or more steps of methods or claims set forth herein, together with one or more apparatus elements or features as depicted and described herein.

Thus, aspects of the invention can be implemented, for example, by one or more appropriately programmed general purpose computers, such as, for example, servers or personal computers, located at one or more of the locations in FIGS. 2 & 5, including within network 208. Such computers can be interconnected, for example, by one or more of payment network 208, another VPN, the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic depicted in the flow chart of FIG. 3 and described herein.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
offering a first plurality of payment device holders a first offer comprising a negotiated deal on a first ware, said negotiated deal on said first ware being available for a first predetermined period of time;
registering those certain holders among said first plurality of payment device holders who wish to accept said first offer, said certain holders among said first plurality of payment device holders comprising first offer accepting holders; said registering of said first offer accepting holders comprising obtaining at least personal identifying information and corresponding registered payment device account numbers for said first offer accepting holders; and
processing a first plurality of transactions in accordance with said negotiated deal on said first ware, wherein said first plurality of transactions comprise purchases of said first ware, by said first offer accepting holders, during said first predetermined period of time;
wherein said step of offering said first offer is carried out by an offeror and wherein said offeror does not require purchase of any product or service other than said first ware for which said negotiated deal is offered in order for said first offer accepting holders to obtain said negotiated deal on said first ware.

2. The method of claim 1, wherein said negotiated deal comprises a negotiated unit price fixed for said first predetermined period of time and independent of a market price for said first ware, further comprising negotiating said negotiated unit price for said first ware with a first merchant.

3. The method of claim 2, further comprising:
negotiating a negotiated unit price for a second ware with a second merchant;
offering a second plurality of payment device holders a second offer comprising said negotiated unit price on said second ware, said negotiated unit price on said second ware being fixed, for a second predetermined period of time, independent of a market price for said second ware;
registering those certain holders among said second plurality of payment device holders who wish to accept said second offer, said certain holders among said second plurality of payment device holders comprising second offer accepting holders, said registering of said second offer accepting holders comprising obtaining at least personal identifying information and corresponding registered payment device account numbers for said second offer accepting holders; and
processing a second plurality of transactions in accordance with said negotiated unit price on said second ware, wherein said second plurality of transactions comprise purchases of said second ware, by said second offer accepting holders, during said second predetermined period of time;
wherein said step of offering said second offer is carried out by said offeror and wherein said offeror does not require purchase of any product or service other than said second ware for which said negotiated unit price is offered in order for said second offer accepting holders to obtain said negotiated unit price on said second ware.

4. The method of claim 3, further comprising selecting said first and second wares based on at least consumer interest and merchant participation.

5. The method of claim 2, wherein said first ware comprises a good.

6. The method of claim 5, wherein said good comprises fuel.

7. The method of claim 2, said first ware comprises a service.

8. The method of claim 7, wherein said service comprises child care.

9. The method of claim 7, wherein said service comprises air travel.

10. The method of claim 2, wherein said negotiated unit price for said first ware is exclusive to a brand of payment device of said first plurality of payment device holders.

11. The method of claim 2, wherein said first offer accepting holders hold payment devices prior to said offering step and wherein said first plurality of transactions are carried out with said payment devices without requiring any supplemental payment devices.

12. The method of claim 2, wherein said first plurality of transactions are carried out by communication between said first merchant and issuers of given ones of said devices, via at least one acquirer and a payment network operating according to a payment system specification, substantially without third party involvement.

13. The method of claim 2, further comprising:
re-negotiating said negotiated unit price for said first ware with said first merchant to obtain a re-negotiated unit price for said first ware for a second predetermined time period;
offering said first offer accepting holders an opportunity to renew said first offer at said re-negotiated unit price;
renewing registration of those certain holders among said first offer accepting holders who wish to renew, said certain holders among said first offer accepting holders comprising renewing holders; and
processing a second plurality of transactions in accordance with said re-negotiated unit price on said first ware, wherein said second plurality of transactions comprise purchases of said first ware, by said renewing holders, during said second predetermined time period.

14. The method of claim 2, wherein said step of processing said first plurality of transactions comprises applying a statement rebate.

15. The method of claim 2, wherein said step of processing said first plurality of transactions comprises adjusting monetary amounts of said first plurality of transactions to reflect said negotiated unit price, contemporaneously with said first plurality of transactions.

16. The method of claim 1, wherein said negotiated deal comprises a negotiated percent discount available for said first predetermined period of time, further comprising negotiating said negotiated percent discount for said first ware with a first merchant.

17. The method of claim 1, wherein said negotiated deal comprises a negotiated fixed discount available for said first predetermined period of time, further comprising negotiating said negotiated fixed discount for said first ware with a first merchant.

18. A method comprising the steps of:
offering a first plurality of payment device holders a first offer comprising a negotiated deal on a first ware, said negotiated deal on said first ware being available for a first predetermined period of time;
registering those certain holders among said first plurality of payment device holders who wish to accept said first offer, said certain holders among said first plurality of payment device holders comprising first offer accepting holders; said registering of said first offer accepting holders comprising obtaining at least personal identifying information and corresponding registered payment device account numbers for said first offer accepting holders; and
processing a first plurality of transactions in accordance with said negotiated deal on said first ware, wherein said first plurality of transactions comprise purchases of said first ware, by said first offer accepting holders, during said first predetermined period of time, and wherein said processing comprises adjusting monetary amounts of said first plurality of transactions to reflect said negotiated deal, contemporaneously with said first plurality of transactions.

19. The method of claim 18, wherein said negotiated deal comprises a negotiated unit price fixed for said first predetermined period of time and independent of a market price for said first ware.

20. An apparatus comprising:
means for facilitating offering a first plurality of payment device holders a first offer comprising a negotiated deal on a first ware, said negotiated deal on said first ware being available for a first predetermined period of time;
means for facilitating registering those certain holders among said first plurality of payment device holders who wish to accept said first offer, said certain holders among said first plurality of payment device holders comprising first offer accepting holders; said registering of said first offer accepting holders comprising obtaining at least personal identifying information and corresponding registered payment device account numbers for said first offer accepting holders; and
means for facilitating processing a first plurality of transactions in accordance with said negotiated deal on said first ware, wherein said first plurality of transactions comprise purchases of said first ware, by said first offer accepting holders, during said first predetermined period of time;
wherein said means for facilitating offering are operated in association with an offeror that does not require purchase of any product or service other than said first ware for which said negotiated deal is offered in order for said first offer accepting holders to obtain said negotiated deal on said first ware.

21. An apparatus comprising:
means for facilitating offering a first plurality of payment device holders a first offer comprising a negotiated deal on a first ware, said negotiated deal on said first ware being available for a first predetermined period of time;
means for facilitating registering those certain holders among said first plurality of payment device holders who wish to accept said first offer, said certain holders among said first plurality of payment device holders comprising first offer accepting holders; said registering of said first offer accepting holders comprising obtaining at least personal identifying information and corresponding registered payment device account numbers for said first offer accepting holders; and
means for facilitating processing a first plurality of transactions in accordance with said negotiated deal on said first ware, wherein said first plurality of transactions comprise purchases of said first ware, by said first offer accepting holders, during said first predetermined period of time, and wherein said means for facilitating processing comprises means for facilitating adjusting monetary amounts of said first plurality of transactions to reflect said negotiated deal, contemporaneously with said first plurality of transactions.

22. A system comprising:
a memory; and
at least one processor, coupled to said memory, and operative to:
facilitate offering a first plurality of payment device holders a first offer comprising a negotiated deal on a first ware, said negotiated deal on said first ware being available for a first predetermined period of time;
facilitate registering those certain holders among said first plurality of payment device holders who wish to accept said first offer, said certain holders among said first plurality of payment device holders comprising first offer accepting holders; said registering of said first offer accepting holders comprising obtaining at least personal identifying information and corresponding registered payment device account numbers for said first offer accepting holders; and
facilitate processing a first plurality of transactions in accordance with said negotiated deal on said first ware, wherein said first plurality of transactions comprise purchases of said first ware, by said first offer accepting holders, during said first predetermined period of time;
wherein said processor is operative to facilitate said offering in association with an offeror that does not require purchase of any product or service other than said first ware for which said negotiated deal is offered in order for said first offer accepting holders to obtain said negotiated deal on said first ware.

23. The system of claim 22, wherein said negotiated deal comprises a negotiated unit price fixed for said first predetermined period of time and independent of a market price for said first ware.

24. A system comprising:
a memory; and
at least one processor, coupled to said memory, and operative to:
facilitate offering a first plurality of payment device holders a first offer comprising a negotiated deal on a first ware, said negotiated deal on said first ware being available for a first predetermined period of time;
facilitate registering those certain holders among said first plurality of payment device holders who wish to accept said first offer, said certain holders among said first plurality of payment device holders comprising first offer accepting holders; said registering of said first offer accepting holders comprising obtaining at least personal identifying information and corresponding registered payment device account numbers for said first offer accepting holders; and
facilitate processing a first plurality of transactions in accordance with said negotiated deal on said first ware, wherein said first plurality of transactions comprise purchases of said first ware, by said first offer accepting holders, during said first predetermined period of time, and wherein said processing comprises adjusting monetary amounts of said first plurality of transactions to reflect said negotiated deal, contemporaneously with said first plurality of transactions.

25. The system of claim 24, wherein said negotiated deal comprises a negotiated unit price fixed for said first predetermined period of time and independent of a market price for said first ware, and wherein said at least one processor comprises at least a front end communications processor associated with a file structure listing said registered payment device account numbers for said first offer accepting holders.
